(19) United States
(12) Patent Application Publication
(10) Pub. No.: US 2013/0185773 A1
(43) Pub. Date: Jul. 18, 2013

(54) APPARATUS, SYSTEM, AND METHOD FOR MANAGING, SHARING, AND STORING SEISMIC DATA

(71) Applicant: Ubiterra Corporation, Denver, CO (US)

(72) Inventor: Peter W. Flanagan, Denver, CO (US)

(73) Assignee: UBITERRA CORPORATION, Denver, CO (US)

(21) Appl. No.: 13/741,272

(22) Filed: Jan. 14, 2013

Related U.S. Application Data
(60) Provisional application No. 61/586,459, filed on Jan. 13, 2012.

(51) Int. Cl. H04L 29/06

(52) U.S. Cl. CPC H04L 63/10
USPC 726/4

(57) ABSTRACT

Implementations described and claimed herein provide a system and methods for managing a flow of and access to proprietary data in a cloud storage array. In one implementation, a plurality of uploads of the proprietary data is received. An association of the proprietary data is maintained across the plurality of uploads. A role is assigned to a party with an interest in the proprietary data. The role is defined by a set of access permissions. The access of the party to the proprietary data is controlled based on the assigned role. The proprietary data may be multi-dimensional data sets, such as raw, processed, and/or interpreted seismic data sets.

### CROSS-REFERENCE TO RELATED APPLICATIONS

The present application claims benefit of priority under 35 U.S.C. §119(e) to U.S. Provisional Patent Application No. 61/594,814, entitled “Apparatus, System and Method for Managing and Storing Seismic Data during Acquisition, Processing and Interpretation” and filed on Jan. 13, 2012, specifically incorporated by reference herein for all that it discloses or teaches.

### TECHNICAL FIELD

Aspects of the present disclosure relate to data management, sharing, and storing services, and more particularly to directory services, transaction services, security services, and archiving or storage services, among other functions, for proprietary data sets.

### BACKGROUND

Many scientific fields involve the collection of sample data in a 3-dimensionally organized form. For example, seismic exploration data, collected in an effort to identify natural gas, oil, water, and/or other underground resources, involves data in x and y horizontal planes and in a z-plane, which is typically associated with time. To collect field seismic data, sometimes referred to as raw seismic data, a seismic survey is conducted, involving seismic waves that are created on the surface. The seismic waves may be initiated in any number of ways, including, for example, through the use of explosives or seismic vibrators. As the seismic waves propagate downward, portions of the waves reflect back to the surface when the waves interact with an underground object, layer, or any number of other possible underground features. The reflected wave data is collected over a wide geographical area. This field seismic data is stored and converted, such as through a process sometimes referred to as stacking, into a form, such as a seismic stack, that can show various underground objects and features in a human readable way through various types of software and user interfaces. Geologists, geophysicists, and others using the processed data and tools can then interpret the data to identify those features associated with the presence of natural gas, shale, oil, water, and other things.

In the case of a seismic stack, the processed stack data is often viewed as various slices or cross-sections taken along the x-axis (inline), the y-axis (cross-line), the z-axis (slice or time direction), or some combination thereof. Since the stack represents a 3-D image of a large underground cube, by viewing various slices through the data, changes in features, underground shapes and contours, and numerous other characteristics of the data may be identified. These data sets are often massive, in some instances on the order of 10's or more gigabytes of data. Visualizing and working with the data requires large amounts of fast data storage and processors.

In the oil and gas industry, information that is gathered when a well is drilled may be placed into the public domain for various reasons, such as increasing the efficiency of exploration efforts. Such publicly available information may be well locations, well tops, oil and gas production features, among other information.

Some information, particularly seismic data, is not placed into the public domain. This information remains proprietary. Nonetheless, companies buy, sell, and trade these valuable datasets as areas are explored and often re-explored. The proprietary data may include the field seismic data, as well as derivative data, such as maps, slices, prospects, and other information obtained or derived based on the primary seismic stack data or the field seismic data.

The conventional methodology for the management of seismic data involves complex data flow and coordination among multiple parties, such as contractors, owners, and partners, among others. These methods are generally inefficient and prone to data loss and disclosure risk. For example, an acquisition contractor may save collected field seismic data to a thumb drive, which is mailed to the owner, partner, or another contractor for review and analysis. Accordingly, a mechanism is needed that effectively and efficiently manages the flow of and access to seismic data and other proprietary data sets.

It is with these observations in mind, among others, that various aspects of the present disclosure were conceived and developed.

### SUMMARY

Implementations described and claimed herein address the foregoing problems by providing an apparatus, system, and methods for managing the flow of and access to proprietary data sets. In one implementation, a plurality of uploads of the proprietary data is received. An association of the proprietary data is maintained across the plurality of uploads. A role is assigned to a party with an interest in the proprietary data. The role is defined by a set of access permissions. The access of the party to the proprietary data is controlled based on the assigned role. The proprietary data may be multi-dimensional data sets, such as field, processed, and/or interpreted seismic data sets.

Other implementations are also described and recited herein.

### BRIEF DESCRIPTION OF THE DRAWINGS

Example implementations are illustrated in referenced figures of the drawings. It is intended that the implementations and figures disclosed herein are to be considered illustrative rather than limiting.

FIG. 1 is an example system for managing the flow of and access to seismic data;

FIG. 2 shows an example user interface displaying a seismic data catalog;

FIG. 3 illustrates the user interface showing a seismic survey map;

FIG. 4 displays the user interface showing details of a survey;

FIG. 5 is the user interface displaying a slice of seismic stack data;

FIG. 6 shows the user interface listing contractors which have been given access to seismic data;

FIG. 7 illustrates the user interface for defining access rights for a contractor;

FIG. 8 displays the user interface listing seismic data to which a contractor has access;

FIG. 9 shows the user interface for editing the details of a survey;

FIG. 10 is the user interface for defining administration settings;

FIG. 11 shows the user interface for defining company settings;

FIG. 12 illustrates the user interface displaying role types;

FIG. 13 is the user interface for defining access rights for a role;

FIG. 14 displays the user interface listing users having access to seismic data;

FIG. 15 shows the user interface for editing user access permissions and settings;

FIG. 16 illustrates an example user interface displaying transfer information for seismic data;

FIG. 17 is a flow chart illustrating example operations for managing the flow of and access to seismic data; and

FIG. 18 is an example computing system that may implement various systems and methods discussed herein.

### DETAILED DESCRIPTION

Aspects of the present disclosure involve apparatuses, systems, and methods for managing the flow of and access to proprietary data sets, such as seismic data sets or other large data sets, in cloud-based computing architectures and other architectures. In one particular aspect, a new survey or project is created using a seismic data application in a cloud computing infrastructure. Role-based access rights to the survey and any associated seismic data for various parties, including an owner that commissioned the seismic survey, any partners of the owner, and any number of contractors, are defined using access controls, including company access rights, business unit access rights, and user access rights.

Field seismic data is acquired and uploaded to the cloud infrastructure as facilitated by the seismic data application. The field seismic data may be in the form of shot records along with ancillary data. Often the field seismic data involves a tremendous number of channels or lines of data taken over a period of time. Once the acquisition of the field seismic data is complete, the field seismic data is downloaded for processing to generate multi-dimensional (e.g., 2-dimensional or 3-dimensional) seismic stack data. The processed seismic data is uploaded to and stored in the cloud infrastructure. The processed seismic data may be accessed to interpret the data, for example, to identify underground horizons, obtain topographic data, obtain filtered data, and/or obtain fault data.

The various apparatuses, systems, and methods disclosed herein provide for the efficient storage and retrieval of massive multi-dimensionally organized data via the cloud, access to and sharing of the data, greater data security and access control, and numerous other advantages and efficiencies over conventional methodologies. The example implementation discussed herein references the multi-dimensional data as a 3-dimensional data seismic stack. However, it will be appreciated by those skilled in the art that the presently disclosed technology is applicable to 2-dimensional seismic data, as well as other types of massive proprietary data, including, but not limited to, medical data (e.g., magnetic resonance imaging (MRI), CT scans, and other medical imaging data), oceanic data, weather data, geological data, and other scientific data.

Some details of the management, storage, retrieval, and sharing of massive proprietary data in a cloud storage array are disclosed more fully in U.S. application Ser. No. 13/654,316 entitled “Apparatus, System, and Method for the Efficient Storage and Retrieval of 3-Dimensionally Organized Data in Cloud-Based Computing Architectures” and filed on Oct. 17, 2012 and in U.S. application Ser. No. 13/657,490 entitled “A System, Method, and Apparatus for Proprietary Data Archival, Directory and Transaction Services” and filed on Oct. 22, 2012. The disclosures of U.S. application Ser. Nos. 13/654,316 (the '316 Application) and 13/657,490 (the '490 Application) are hereby incorporated by reference.

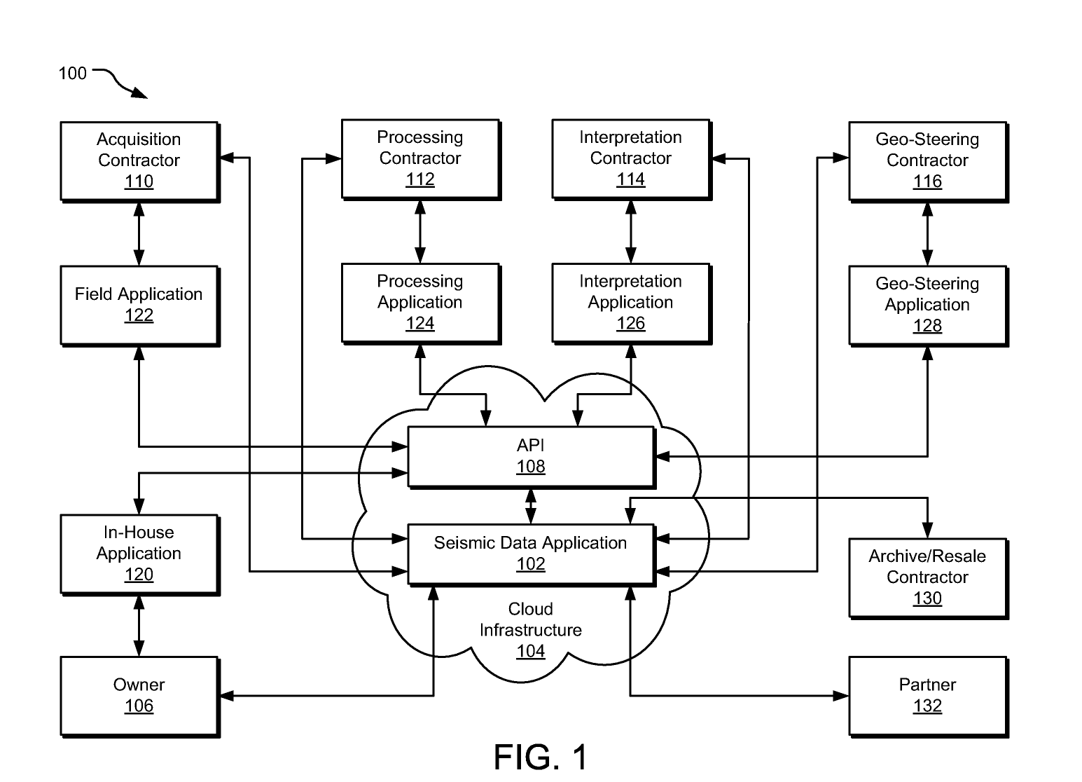

Referring to FIG. 1, an example system 100 for managing the flow of and access to seismic data is shown. As can be understood from FIG. 1, a seismic data application 102 is implemented in a cloud infrastructure 104. The system 100 contemplates a range of possible cloud storage solutions ranging from a dedicated processor, input/output (I/O) and storage, to a processor or processors executing various threads for reading and writing data into and out of a virtualized storage node. The architecture of the cloud infrastructure 104 as well as the storage and retrieval of seismic data in a cloud-based computing architecture is described in detail in the '316 Application and the '490 Application. The cloud-based seismic data application 102 links a plurality of parties via a network (e.g., the Internet) to bring a uniform and controlled process to the acquisition, processing, interpretation, archiving, and sharing of seismic data.

As can be understood from FIG. 1, the system 100 provides an efficient, high speed exchange of massive seismic data and other files and increases collaboration and quality control during the acquisition, processing, and interpretation of the seismic data. Further, the seismic data is secured in the cloud infrastructure 104 where access and operations against the data are controlled using role-based access rights and project status. The seismic data is archived together such that a relationship among field seismic data, ancillary data, processed seismic data, and interpreted seismic data (i.e., processed seismic data and corresponding metadata), among other information is maintained across acquisition, processing, and interpretation projects. Finally, the system 100 provides keyword and spatial lookup for easy locating and accessing of data.

In one implementation, the parties (e.g., an owner 106) may access and interact with the seismic data application 102, directly, for example, through a user device running a browser or other web-service that can interact with the cloud infrastructure 104 by way of the network. The user device is generally any form of computing device, such as a work station, personal computer, portable computer, mobile device, or tablet, capable of interacting with the cloud infrastructure 104.

In another implementation, the parties may access and interact with the seismic data application 102 from software running on the user device utilizing an interface such as an application programming interface (API) 108. Stated differently, the API 108 can be called from an application or other software on the user device to pull or push seismic data to and from the cloud infrastructure 104. The seismic data may be accessed in a variety of formats, such as SEG-Y files, or using higher-level constructs, including, but not limited to, lines, images, and map objects. Accessing the seismic data using the API 108 increases efficiency of sharing and working with the seismic data by eliminating or otherwise reducing the need for reformatting data for software that utilizes specific internal formatting for seismic data. Alternatively or additionally, the system 100 may include plug-ins for various software applications to translate the format of the seismic data into the internal formatting required by a particular seismic software application.

The owner 106 is a client that commissioned a seismic survey and that generally owns any proprietary information obtained from the seismic survey, including field seismic data (i.e., shot records), processed seismic data (i.e., data obtained through any alteration or processing of the original field data, such as pre-stack processed data and post-stack processed data), and any interpreted seismic data (i.e., the processed seismic data and metadata, such as notes, annotations, digitized horizons, digitized geologic fault planes, specialized metadata, etc.). Sometimes, the owner 106 will perform one or more of acquisition, processing, interpretation, geo-steering, or archiving services in-house using, for example, an in-house application 120. On the other hand, the owner 106 may hire various contractors 110, 112, 114, 116, and 130 to perform these and other services.

Other interested parties, such as a partner 132, may have access rights to the seismic survey and any associated seismic data. For example, should the partner 132 obtain a license or other rights to access the data of the owner 106, copies of the data are stored in the cloud infrastructure such that they are accessible to the partner 132. In some instances, the partner 132 may also be a contractor that will perform some action on the data set for the owner 106.

The owner 106, the partner 132, and the contractors 110, 112, 114, 116, and 130 may each have their own accounts permitting them to log into the seismic data application 102 to access any seismic surveys that they have created or that have been shared with them. If one or more of the owner 106, the partner 132, and the contractors 110, 112, 114, 116, and 130 do not have an account, a party can request an account be created. For example, if one of the contractors 110, 112, 114, 116, or 130 does not have an account, the owner 106 may request an account be set up for that contractor with the seismic survey for which the contractor was hired to perform services added to the contractor's account. The contractor may then access surveys, seismic data, and other proprietary data according to role-based access rights and project statuses, which may be defined by the owner 106, an administrator, or another interested party.

The role-based access rights assign a role (e.g., administrator, seismic user, seismic viewer, acquisition, etc.) to a party. The role is defined based on a set of access permissions selected from available access permissions, which limit access to and operations against seismic data. For example, the available access permissions may include a right to: login; view a seismic catalog listing active surveys; create seismic surveys; delete seismic surveys and data sets; upload seismic data; download seismic data; view seismic sections; transfer seismic data to other parties; temporarily share seismic data with other parties; view a seismic actions log detailing the activity of parties relating to a survey; attach documents to seismic data; delete documents attached to seismic data; connect via the API 108; view documents attached to seismic data; make seismic journal entries; and delete seismic journal entries. However, other access permissions are contemplated.

In one implementation, the administrator role allows the highest level of access. On the other hand, a party assigned a seismic viewer role is generally limited to logging in and viewing seismic data. A party having a seismic user role is permitted a higher level of access permissions to be able to work with the seismic data without having the ability to delete any surveys or data sets. Finally, a party in an acquisition role is generally permitted to upload and access seismic data. In some implementations, a party may be assigned more than one role. Further, additional roles, including, without limitation, limited seismic user, limited seismic viewer, limited acquisition, project manager, etc. are contemplated.

It will be understood by those skilled in the art that the access permissions for each of the roles may be edited or otherwise defined to globally apply to each party assigned a particular role or to apply to individual parties. Stated differently, the owner 106 may define the seismic viewer role to have a particular set of access permissions that apply to every contractor assigned the seismic viewer role, or the owner 106 may assign an individual contractor the seismic viewer role, thereby populating a set of access permissions which may then be further edited or defined by the owner 106 for that individual contractor.

In one implementation, the role-based access rights may be defined using access controls, including, but not limited to, company access rights, business unit access rights, and user access rights. Company access rights control access to seismic surveys, seismic data, and other proprietary data for an entire company, allowing any personnel at that company with login credentials to access or interact with the surveys and data according to the set of access permissions defined by the role assigned to the company. For example, the owner 106 may share a seismic survey, and any associated seismic or proprietary data, with the partner 132 in a seismic viewer role capacity. As such, any personnel employed by the partner 132 would be able to access the survey and data based on the access permissions defined for the seismic viewer role.

Further, within a company, access rights may be defined for business units, such that any personnel within a business unit has access according to an assigned role, while any personnel at the company outside of the business unit are denied access. For example, the owner 106 may have several business units corresponding to different geographical regions or different employee levels, for example, a North American division, a South American division, Corporate/Executive division, etc. The owner 106 may set the access rights limit access to a particular survey and seismic data to personnel in the North American division. As such, all the personnel in the North American division would be able to access the seismic survey and data according to the access permissions defined for the role assigned the North American division business unit, and all the personnel outside of the North American division would be denied access.

Finally, access rights may be defined on a user by user basis. Within a company, individual users may be assigned different roles. For example, the owner 106 may have a corporate executive assigned the administrator role and an analyst assigned a seismic viewer role. In one implementation, guest users outside a company may be assigned a role to provide access to a particular individual without having to provide access to every employee at the company the particular individual works for. For example, the owner 106 may hire an individual as an independent contractor to perform services for a seismic survey. Rather than provide access to people not working on the project, thereby increasing disclosure and data corruption risk, the owner 106 may assign the individual a role to provide temporary access to the individual while his/her services are being performed.

In addition to controlling access to seismic surveys, seismic data, and other proprietary data using role-based access rights, the seismic data application 102 controls access using project statuses. When a party shares or otherwise permits access to seismic surveys or data with another party, the access may be defined based on the status of a project (e.g., active, complete, etc.). For example, the owner 106 may hire a contractor to perform acquisition services relating to a seismic survey. To limit the access rights of the contractor to the acquisition project, the owner 106 may set the status of the acquisition project to active or complete. When the project is active, the contractor has access rights to the seismic survey and data based on assigned role-based access rights. Once the project is complete, the contractor is restricted from accessing the seismic survey and data. Further, other project statuses updating parties on the progress of a project may update or otherwise impact access rights. Additionally, the access rights may be defined by a length of time, such that a party has access rights as defined by a role unit the length of time expires, thereby terminating the access rights. For example, the length of time may be defined based on a contract term.

In some implementations, the seismic data application 102 provides further security and access control services, including, but not limited to, data encryption (e.g., using an AES 256 encryption algorithm, or other encryption algorithm), an activity log, and other means. As described herein, the activity log details all activity relating to a seismic survey, data, or project by each associated user, company, business unit, etc. As such, if any problems occur, the owner 106 can track the origin of the problem.

On top of security and access control services, the seismic data application 102 brings a uniform and controlled process to the acquisition, processing, interpretation, archiving, and sharing of seismic data. Once the owner 106 creates and activates an acquisition project, an acquisition contractor 110 can connect to the seismic data application 102 directly or from a field application 122 by way of the API 108. The acquisition contractor 110 acquires field seismic data from the survey site, which is often collected as numerous individual shot records and any ancillary data (e.g., Ob note files, SPS files, and survey files).

Conventional methods involved the acquisition contractor 110 copying daily field seismic data on a portable storage device (e.g., a thumb drive) and mailing the device to interested parties for review and processing. Such methods generally result in substantial delays in waiting for the owner 106 or another interested party to make key decisions, such as approving the quality of the field seismic data. Further, such methods increase the risk of data loss and disclosure. In other words, nothing in conventional methods protects against the portable storage device being lost in the mail or the field seismic data otherwise being destroyed or against an unauthorized third-party from intercepting or obtaining the field seismic data.

Accordingly, the system 100 provides for the acquisition contractor 110 to securely upload and store the field seismic data in the cloud infrastructure 104 as it is acquired. The field seismic data may be encrypted when it is uploaded into the cloud infrastructure 104. In one implementation, the field seismic data is automatically uploaded after each shot is recorded or on regular time intervals. To achieve this, the acquisition contractor 110 may utilize a computing device on-site that is equipped with an IP connection via satellite, cellular networks, or some other means. Each time the shot is recorded, the shot record is copied to a local file directory, where the seismic data application 102 identifies it and executes an upload to the account associated with the survey, for example, as detailed in the '316 Application.

In another implementation, the field seismic data is collected and stored on a portable storage device, which may be connected to a user device for manual upload. For example, the acquisition contractor 110 may travel to a location with an internet connection to log into the seismic data application 102. The acquisition contractor 110 selects the appropriate account and survey and uploads the field seismic data and any ancillary data from the portable storage device.

Once the seismic data application 102 uploads the field seismic data, in one implementation, the acquisition contractor 110 and/or the owner 106 are notified. For example, the seismic data application 102 may generate an email to the acquisition contractor 110 and to the owner 106 describing the action performed. The seismic data application 102 may further track the accumulated actions of the acquisition contractor 110 and organize the field seismic data acquired into an activity log, which may be accessed by interested parties based on their role-based access rights.

As the acquisition project progresses and field seismic data is collected and uploaded into the cloud infrastructure 104, the owner 106, the partner 132, and/or one or more of the contractors 110, 112, 114, 116, 130 may view and analyze the field seismic data for quality control and other purposes.

For example, the owner 106 may use the activity log to review each of the previous day's shot records. The seismic data application 102 may include a plurality of display settings allowing the owner 106 to optimize the review by changing scale, gain, agc, bandpass filter, and other settings. Further, the owner 106 may perform a “rubber-band select” using an input device, such as a mouse. The rubber-band select displays a pop-up power spectrum for a portion of the shot record. Additionally, the acquisition contractor 110 may upload test shot records, which are identified as such by the seismic data application 102. The test shot records may be downloaded for specialized analysis.

For each of the shot records, the owner 106 or interested party may indicate that a quality control check has been performed on the field seismic data, whether each of the shot records are acceptable, and/or any feedback on the shot records. For example, wind noise, commercial noise, or other noise occurring during certain times may impact the quality of the field seismic data. The owner 106 may provide feedback noting that the acquisition contractor 110 should collect the field seismic data outside of these certain times.

Once the owner 106 or interested party is satisfied with the quality of the field seismic data, the acquisition project is complete. Once the acquisition project is complete, the seismic data application 102 restricts or denies the acquisition contractor 110 access to the field seismic data depending on the role-based access rights defined by the owner 106. The owner 106 may download the complete field seismic data and close the account or archive the field seismic data in the cloud infrastructure 104. In one implementation, the field seismic data is deleted from the cloud infrastructure 104, but the account of the owner 106 is left intact for future projects with the acquisition contractor 110. In another implementation, the account is deleted completely. In still another implementation, the field seismic data is archived in the cloud infrastructure 104 for a processing project.

In one implementation, the owner 106 allows controlled access to the field seismic data and any ancillary data by a processing contractor 112. Stated differently, the owner 106 adds the processing contractor 112 to a seismic processing contractor list for the survey and activates the access as defined by the role-based access rights set by the owner 106 for the processing contractor 112.

The processing contractor 112 downloads the field seismic data and ancillary data or processes the data in a processing application 124 by way of the API 108. The processing contractor 112 generates multi-dimensional seismic stack data from the field seismic data. Processed seismic data may refer to data that is obtained through any alteration or processing of the original field data, such as pre-stack processed data and post-stack processed data. Pre-stack and post-stack processed data refer to data the has undergone processing before being coalesced into a final stack and after being coalesced into a final stack, respectively. The seismic data application 102 uploads and stores the processed seismic data in the cloud infrastructure 104. During the processing, the owner 106 or other interested parties may review and analyze the seismic stack data for quality control and other purposes. In one implementation, the owner 106, the processing contractor 112, and/or other interested parties may create annotations in the form of notes and drawings, which are applied directory to and stored with the seismic data. In other words, uploaded attachments and metadata may be stored with and managed along corresponding seismic data.

Once the owner 106 or interested party is satisfied with the quality of the seismic stack data, the processing project is complete. Once the acquisition project is complete, the seismic data application 102 restricts or denies the processing contractor 112 access to the processed and field seismic data depending on the role-based access rights defined by the owner 106. The owner 106 may download the complete seismic stack data and close the account or archive the processed seismic data in the cloud infrastructure 104 for an interpretation project.

In one implementation, the owner 106 allows controlled access to the processed seismic data by an interpretation contractor 114. Stated differently, the owner 106 adds the interpretation contractor 114 to a seismic interpretation contractor list for the survey and activates the access as defined by the role-based access rights set by the owner 106 for the interpretation contractor 114.

The interpretation contractor 114 downloads the seismic stack data or analyzes the data in an interpretation application 126 by way of the API 108. In one implementation, the system 100 includes a plug-in for the interpretation application 126 to translate the format of the seismic data stored in the cloud infrastructure 104 into a format required by the interpretation application 126. The interpretation contractor 114 interprets the data, for example, to identify underground horizons, obtain topographic data, obtain filtered data, and/or obtain fault data. The interpretation contractor 114, the owner 106, and/or other interested parties views the processed seismic data and creates metadata from the processed seismic data. In other words, interpreted seismic data includes processed seismic data and corresponding metadata. The seismic data application 102 uploads and stores the interpreted seismic data in the cloud infrastructure 104. During the interpretation, the owner 106 or other interested parties may review and analyze the interpreted seismic data for quality control and other purposes.

Metadata, for example in the form of annotations, drawings, digitized horizons, digitized geologic fault planes, specialized metadata, etc. on processed seismic data (e.g., on cross-sectional views, map views, etc.), is very important in the oil and gas industry with respect to interpretation services. For example, it is beneficial to have a complete repository for final interpreted seismic data for sharing, viewing, and other collaboration. As such, meta-data created within the seismic data application 102 is retained in the cloud infrastructure 104, and metadata created in the interpretation application 126 may be uploaded to the cloud infrastructure 104. The metadata is stored and managed along with the processed and interpreted seismic data.

Once the owner 106 or interested party is satisfied with the quality of the interpreted seismic data, the interpretation project is complete. Once the interpretation project is complete, the seismic data application 102 restricts or denies the interpretation contractor 114 access to the interpreted, processed, and field seismic data depending on the role-based access rights defined by the owner 106. The owner 106 may download the interpreted seismic data and close the account or archive the interpreted seismic data in the cloud infrastructure 104. Accordingly, the system 100 provides a uniform storage location and directory for aggregating seismic data prior to and including obtaining and interpreting seismic stack data.

In some instances, a geo-steering contractor 116 may be provided access to the seismic data while drilling to adjust a borehole position on the fly to reach one or more geological targets. The owner 106 or other interested parties may set the role-based access rights of the geo-steering contractor 116, such that the geo-steering contractor 116 may access and interact with the seismic data directly or in a geo-steering application 128 by way of the API 108.

Finally, an archive/resale contractor 130 may be given role-based access rights to the seismic data to create an additional archive of the seismic data or to sell, license or otherwise transfer the seismic data. In one implementation, transfer rights may be assigned to parties using the role-based access rights. The right to transfer may include permission to provide a copy of seismic data or other proprietary data to another party, to license or sub-license the seismic data, or other transfer rights. The seismic data application 102 may track the custody of such data from one party to another as it is transferred, as well as the terms of the transfer. Further, the seismic data application 102 may be configured to require a party to accept or digitally sign a license or transfer contract prior to receiving the seismic or proprietary data. Apparatuses, systems, and methods for transferring of the seismic data is described more fully in the '490 Application.

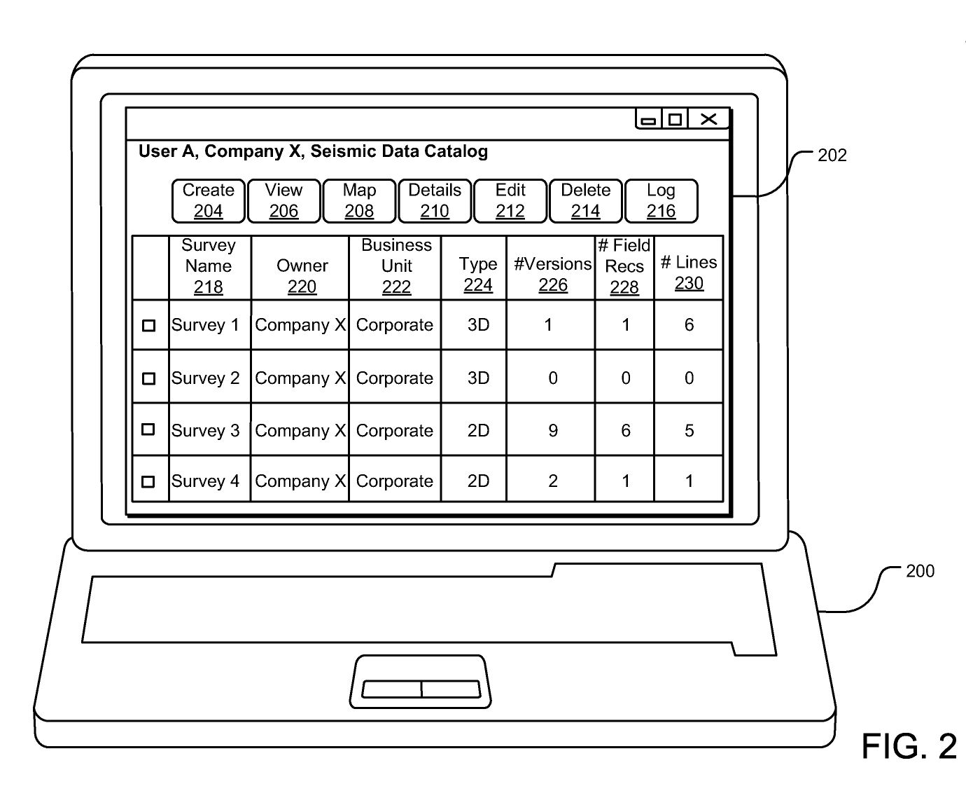

FIGS. 2-16 show an example user interface 200 through which access to and interactions with seismic surveys and data are controlled and other actions are taken with the seismic data application 102. It will be appreciated by those skilled in the art that such depictions are exemplary only and not intended to be limiting.

Turning to FIG. 2, the user interface 200 displays a seismic data catalog 202 to which User A at Company X has access. The seismic data catalog 202 lists each of the active or archived surveys which have been created by or shared with Company X that User A is permitted to access based on assigned roles.

In one implementation, the seismic data catalog 202 displays a create button 204, a view button 206, a map button 208, a details button 210, an edit button 212, a delete button 214, and a log button 216. The create button 204 may be selected to create a new seismic survey.

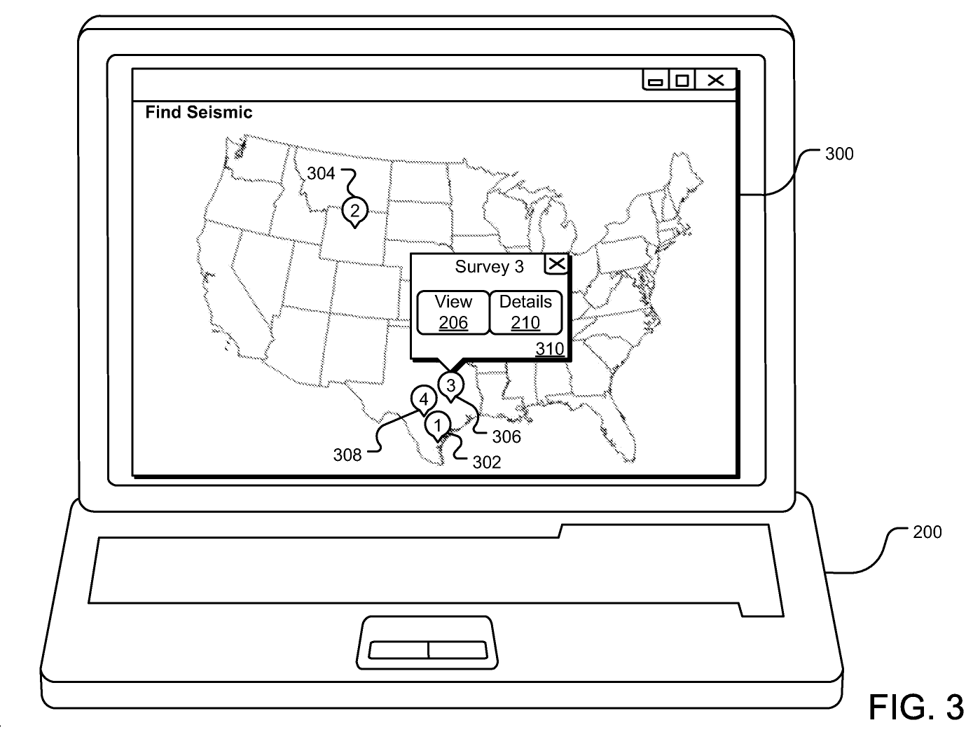

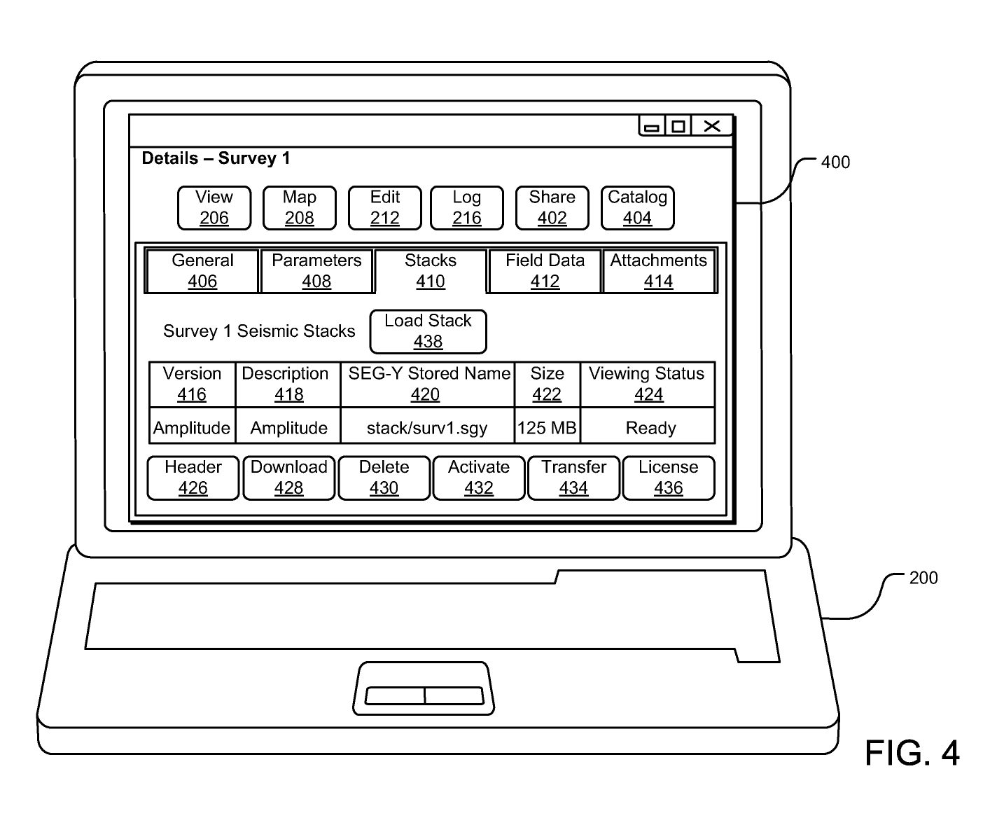

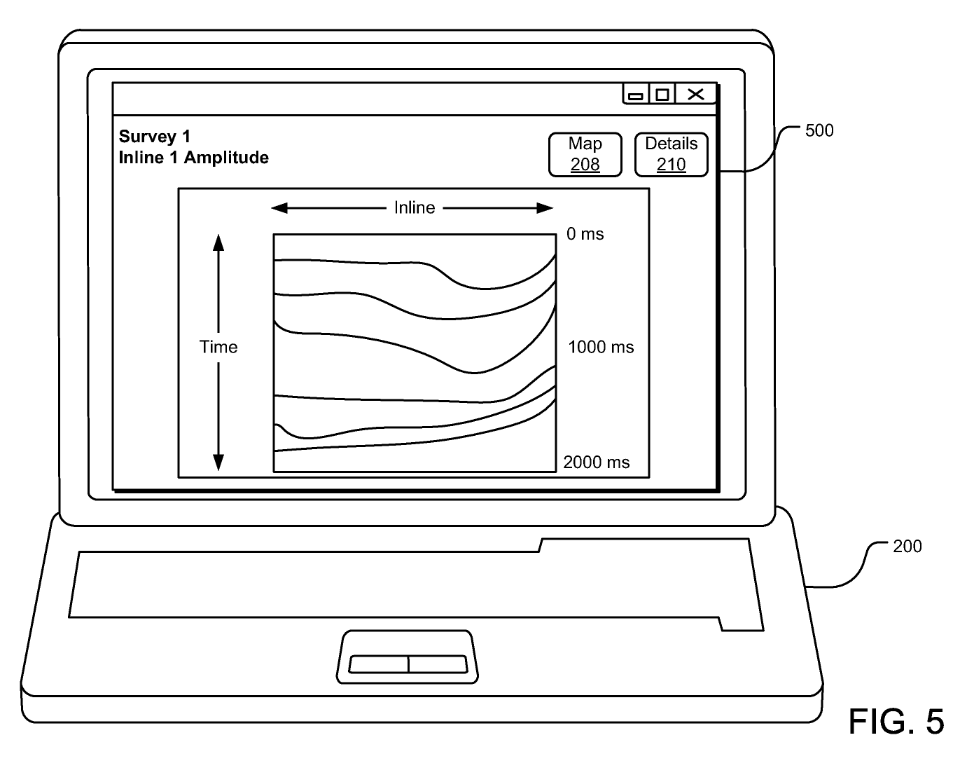

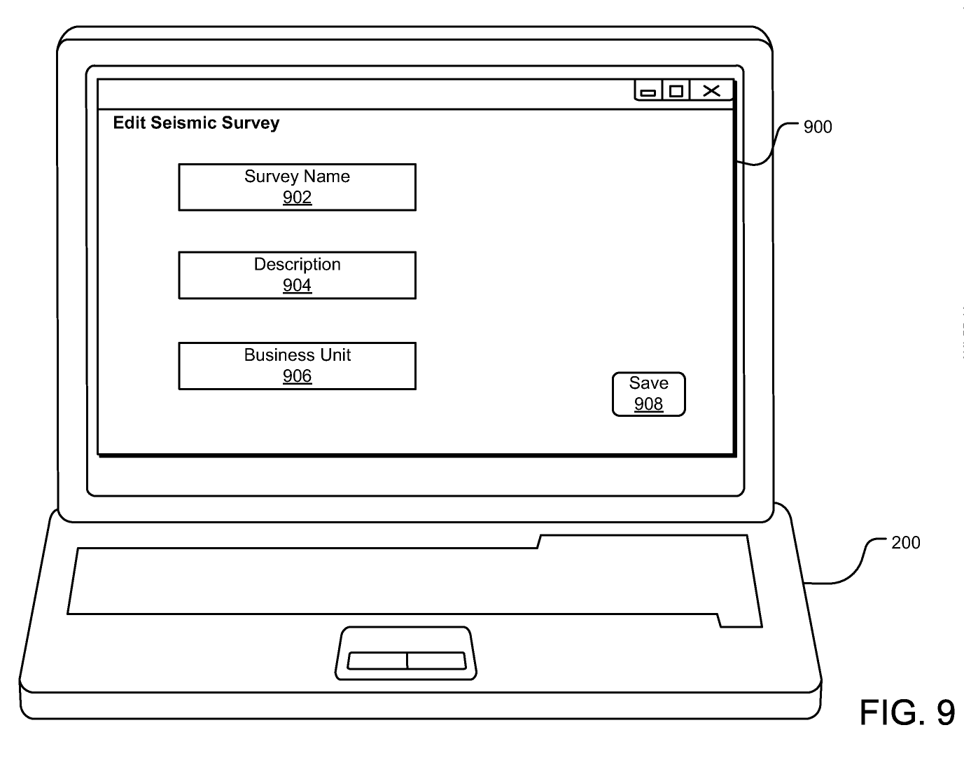

The additional buttons 206, 208, 210, 212, 214, and 216 may be selected along with at least one of the listed surveys to perform various functions relating to the selected surveys. The map button 208 provides a link to a geographical map visually presenting the location of each survey listed in the seismic data catalog 202 (e.g., see FIG. 3). The details button 210 provides details relating to survey, including field, ancillary, processed, and interpreted seismic data and other information relating to the survey (e.g., see FIG. 4.) The view button 206 may be selected to review a cross section, slice, stack, or other field, processed, or interpreted seismic data (e.g., see FIG. 5). The edit button 212 permits editing of general information pertaining to a survey (e.g., see FIG. 9). The delete button 214 deletes a selected survey and any associated data sets. Various mechanisms may be present to prevent a survey from being accidentally deleted. Finally, the log button 216 provides access to the activity log described herein that details all the activity of each party relating to a selected survey.

In one implementation, the seismic data catalog 202 displays information relating to each of the active or archived surveys, including: a survey name 218; an owner 220 of the survey; a business unit 222 within Company X that has role-based access rights to the survey; a type 224 of survey (e.g., 3-dimensional, 2-dimesional, etc.); a number of versions 226 that are stored with respect to the survey, a number of field recordings 228 listing the amount of shot records uploaded; and a number of lines 230 detailing the channels of data taken over a period of time.

Referring to FIG. 3, the user interface 200 shows a seismic survey map 300 of the surveys listed in the seismic data catalog 202. The map 300 displays the geographical location of each of the surveys by identifying them, for example, with numbered balloons 302, 304, 306, and 308 on a map. Rolling over or selecting one of the balloons (e.g., the balloon 306) with a user input device generates a pop-up window 310 allowing a user to select the view button 206 or the details button 210 to obtain or gain access to additional data associated with Survey 3.

The user interface 200 in FIG. 4 displays survey details 400 of Survey 1, one of the surveys that was listed in the seismic data catalog 202. In addition to the buttons 206, 208, 212, and 216, the survey details 400 provides a share button 402 and a catalog button 404. The share button 402 allows a party (e.g., a company, business unit, or user) with appropriate share access permissions to share Survey 1 or seismic or proprietary data associated with Survey 1 with other parties. The catalog button 404 returns to the seismic data catalog 202.

The seismic details 400 display and provide access to a general tab 406, a parameters tab 408, a stacks tab 410, a field data tab 412, and an attachments tab 414. Each of the tabs 406, 408, 410, 412, and 414 provides access to seismic data or information, as described herein. In one implementation, the general tab 406 provides general information about Survey 1, and the parameters tab 408 details the parameters set and observed during acquisition, processing, interpretation, or other seismic services. In some implementations, the general information and parameters may be edited from the general tab 406 and the parameters tab, respectively. The field data tab 412 provides a link to field seismic data acquired for Survey 1, and the attachments tab 414 directs a user to attachments to the seismic data. From the field data tab 412, the field seismic data may be uploaded, downloaded, viewed, or analyzed. Similarly, the attachments tab 414 allows for the uploading, downloaded, viewing, etc. of attachments based on the role-based access rights.

Finally, the stacks tab 410, which can be seen in FIG. 4, displays each of the seismic stacks uploaded for the Survey 1. Information pertaining to the seismic stacks includes a version 416, a description 418 of the stack, the stored file name 420 in SEG-Y formatting, the size 422 of the stack, and the viewing status 424 indicating whether the stack is ready for review, for example, for approval, quality control, or discussion.

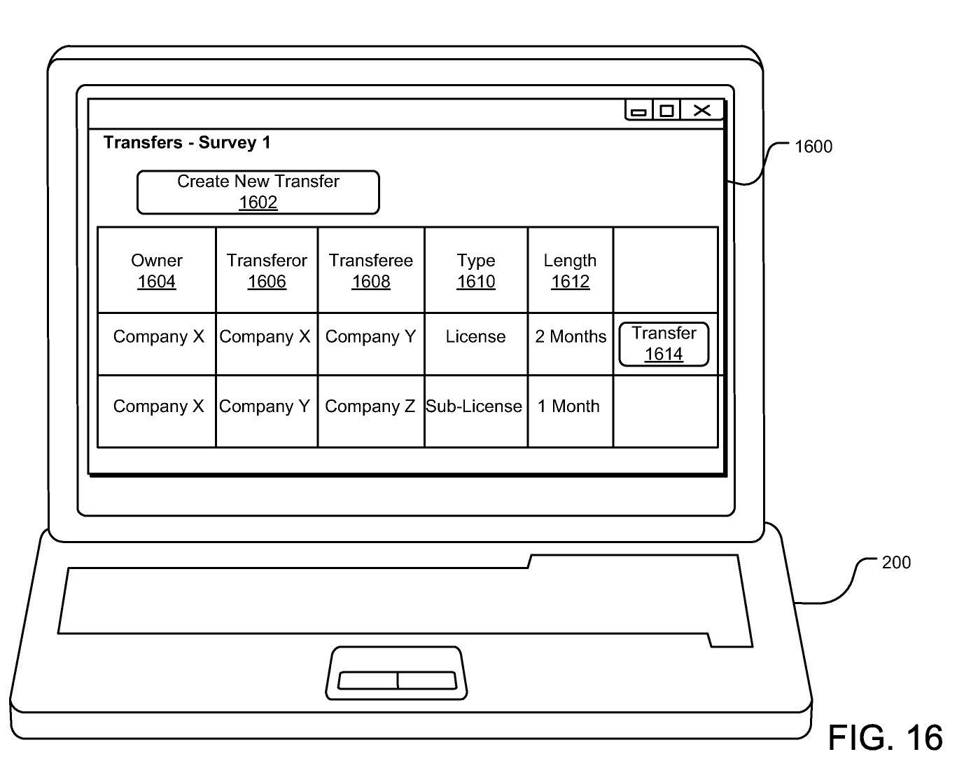

For each of the stacks displayed in the stacks tab 410, various buttons 426, 428, 430, 432, 434, 436, and 438 may be selected to perform various functions or services relating to the stack in accordance with the role-based access rights. For example, the download button 428 and the delete button 430 allow a party to download or delete the stack, respectively. The activate button 432 may be used, for example, to activate seismic data, or a seismic project. The transfer button 434 allows a party to provide a copy of the stack to another party, and the license button 436 displays license and data custody information relating to the stack. (e.g., see FIG. 16). The load stack button 438 may be selected to review a cross section, slice, stack, or other processed seismic data, for example, the slice 500 of Survey 1 shown in FIG. 5.

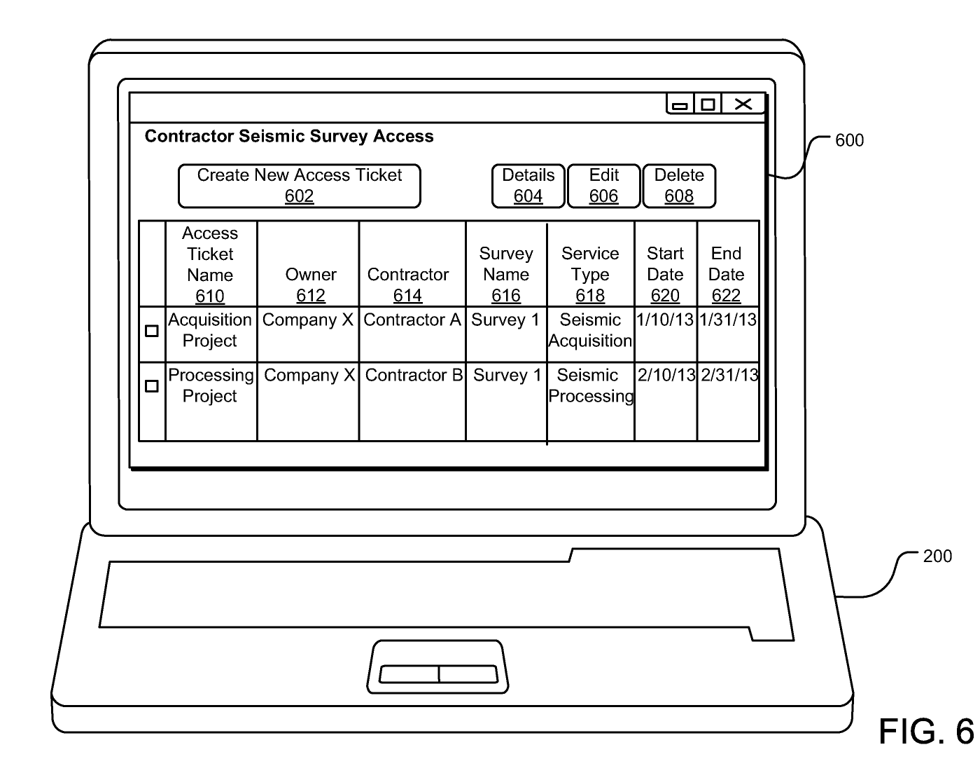

As can be understood from FIG. 6, a contractor seismic survey access list 600 displays a list of contractors that have been given access to seismic data. In one implementation, the contractor seismic survey access list 600 is visible to an owner (e.g., Company X) to track the various contractors having access to a survey or data sets as well as the status of that access.

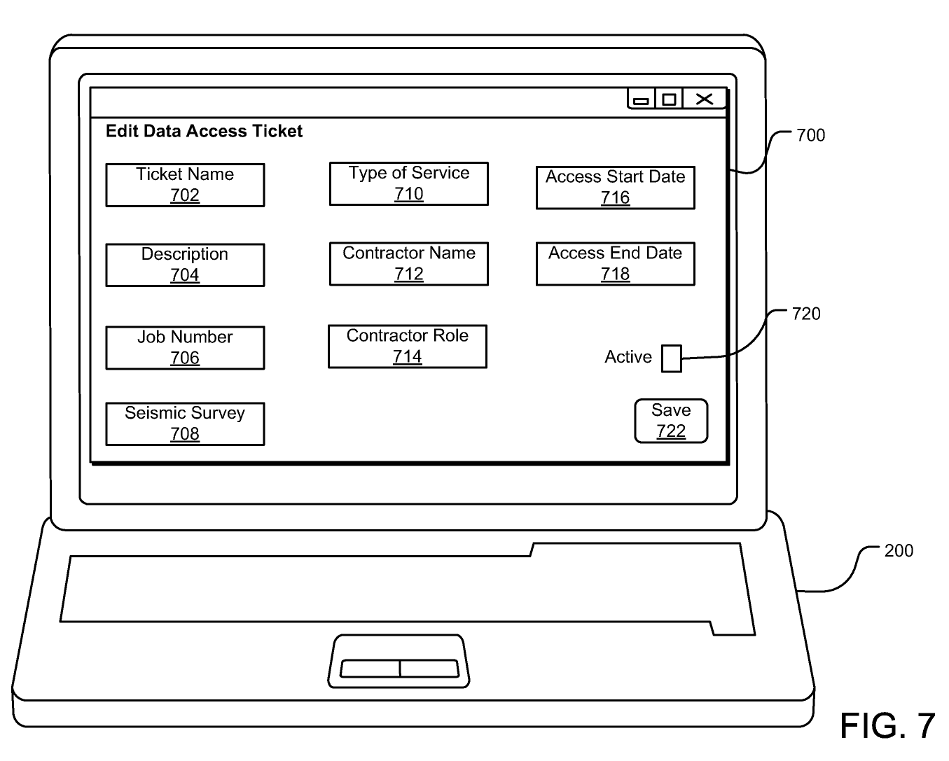

In one implementation, the contractor seismic survey access list 600 includes buttons 602, 604, 606, and 608 for performing functions defining or otherwise relating to the access of a contractor. The create new access ticket button 602 permits the addition of a new contractor to the contractor seismic survey access list 600 with defined role-based access rights and access terms (e.g., see FIG. 7), while the buttons 604, 606, and 608 link to functions defining or impacting existing contractor access tickets. For example, the details button 604 displays the details of an access ticket, the edit button 606 edits the access ticket, and the delete button 608 deletes the access ticket.

Information regarding existing access tickets is displayed in the contractor seismic survey access list 600. In one implementation, an access ticket name 610, an owner 612 that commissioned the survey, a contractor name 614 associated with the access ticket, a survey name 616, a service type 618, a start date 620 and an end date 622 are shown. The start date 620 and the end date 622 may be used to define access according to project status. For example, with respect to the example shown in FIG. 6, if the current date is Feb. 10, 13, Contractor B would have access to the Survey 1 and any seismic data for which Contractor B has permission to access, but Contractor A would be denied access to Survey 1 and any associated data sets.

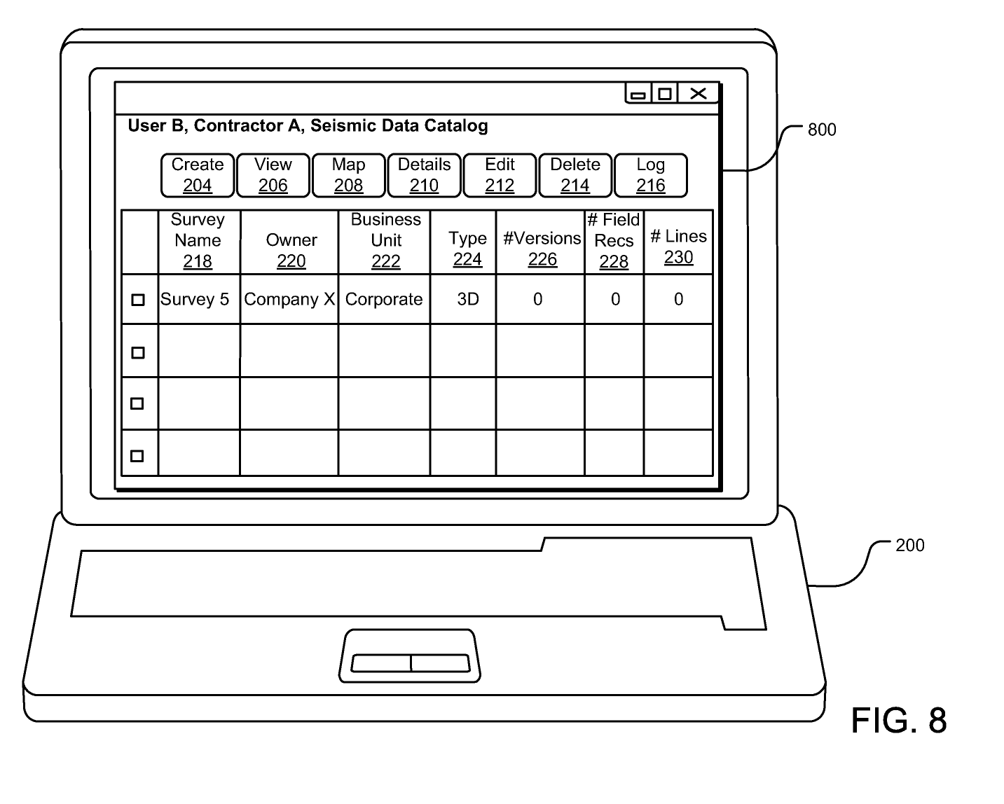

Turning to FIG. 7, a data access ticket 700 may be used to define access rights for a contractor. In one implementation, an existing contractor access ticket may be edited or a new contractor access ticket may be created using the fields 702-720 shown in FIG. 7. The ticket name field 702 sets a name for the access ticket that will be displayed as the access ticket name 610 in the contractor seismic survey access list 600. The description field 704 is used to describe the access ticket, survey, or any other relevant information. The job number field 706 defines a job number that the party may use to track access tickets. The seismic survey field 708, the type of service field 710, the contractor name field 712, the access start date 716, and the access end data field 718 correspond to the survey name 616, the service type 618, the contractor name 614, the start date 620, and the end date 622 displayed in the contractor seismic survey access list 600, respectively. The contractor role field 714 may be used to assign a role (e.g., administrator, seismic viewer, seismic user, or acquisition) to the contractor, as described herein. The active box 720 activates and deactivates the contractor access ticket. Finally, the save button 722 may be selected to save the contractor access ticket, which will then show up on the contractor seismic survey access list 600 and a contractor seismic data catalog 800, shown in FIG. 8.

The contractor seismic data catalog 800 lists the surveys and seismic data to which a contractor has access. For example, as can be understood from FIG. 8, if an owner (e.g., Company X) were to create and activate an access ticket for Contractor A to perform services for Survey 5, the Survey 5 would show up in Contractor A's seismic data catalog 800 with details about Survey 5.

Referring to FIG. 9, an editing page 900 may be used to edit the details of a survey using one or more fields, including a survey name field 902, a description field 904, and a business unit field 906. The information input into the survey name field 902 and the business unit field 906 will be displayed, for example, in the seismic data catalog 202 and/or the contractor seismic data catalog 800 as the survey name 218 and the business unit 222, respectively.

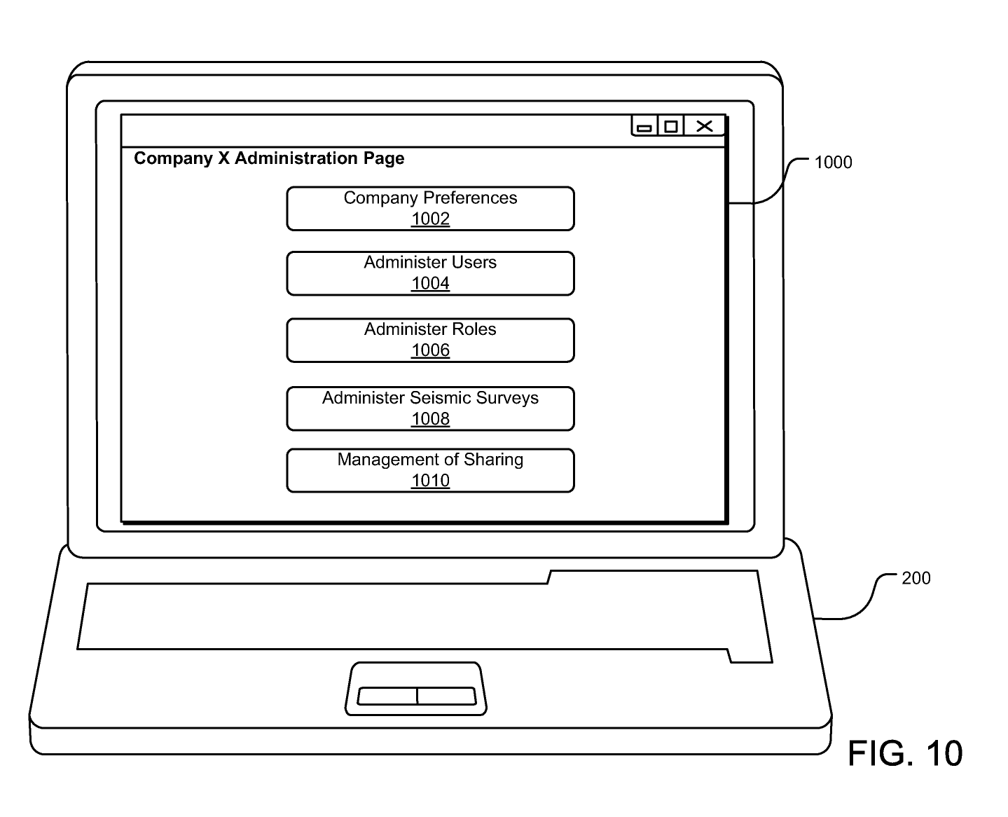

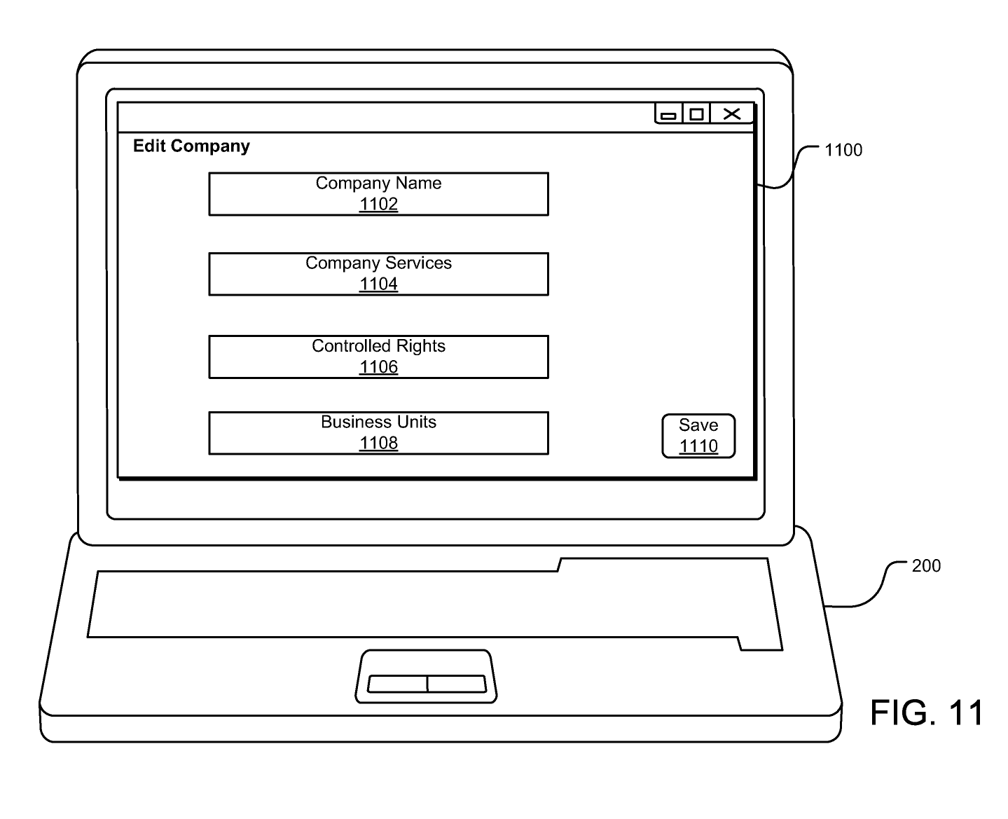

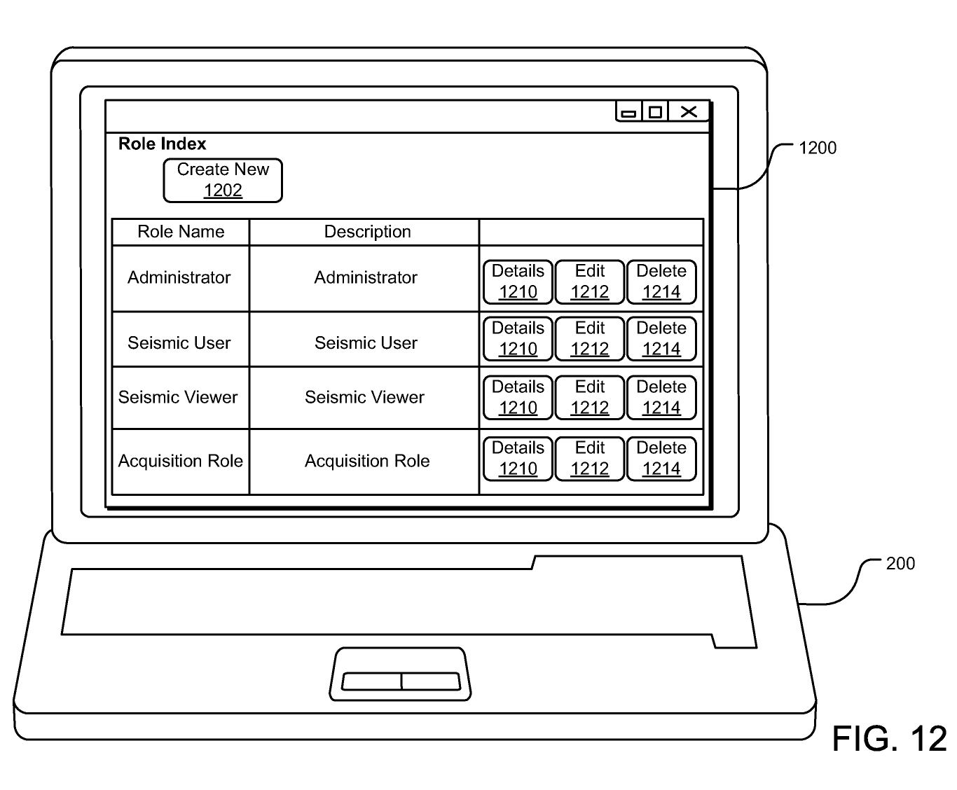

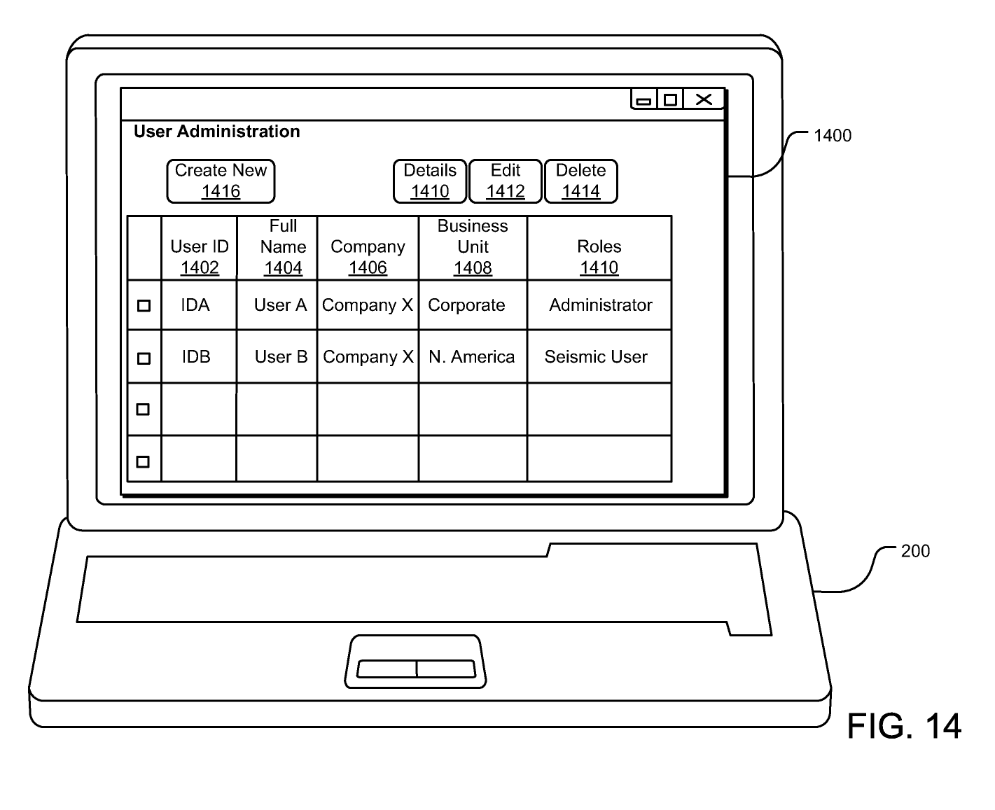

FIG. 10 shows administration settings 1000. In one implementation, the administration settings 1000 include company preferences 1002, administer users 1004, administer roles 1006, administer seismic surveys 1008, and management of sharing 1010. The administration settings 1000 permit access controls, sharing, and other functions to be defined. For example, the company preferences 1002 provides a link to a company settings 1100 as shown in FIG. 11; the administer users 1004 accesses a user roster 1400 as illustrated in FIG. 14; and the administer roles provides a link to role index 1200 as shown in FIG. 12.

Referring to FIG. 11, the company settings 1100 is shown. The company settings 1100 may be used to edit information about a company using one or more fields, including a company name field 1102; a company services field 1104 specifying the services the company is to perform; a controlled rights field 1106 detailing rights associated with the company, including role-based access rights, and a business units field 1108 specifying active divisions or units within the company, which may be assigned access rights. The save button 1110 saves the company settings 1100.

FIG. 12 illustrates the role index 1200 displaying existing role types and a create new button 1202 to create additional role types with associated access permissions. The role index 1200 displays the role name and description, and for each role, a details button 1210, an edit button 1212, and a delete button 1214 is provide to obtain details, edit the role settings, or delete the role, respectively.

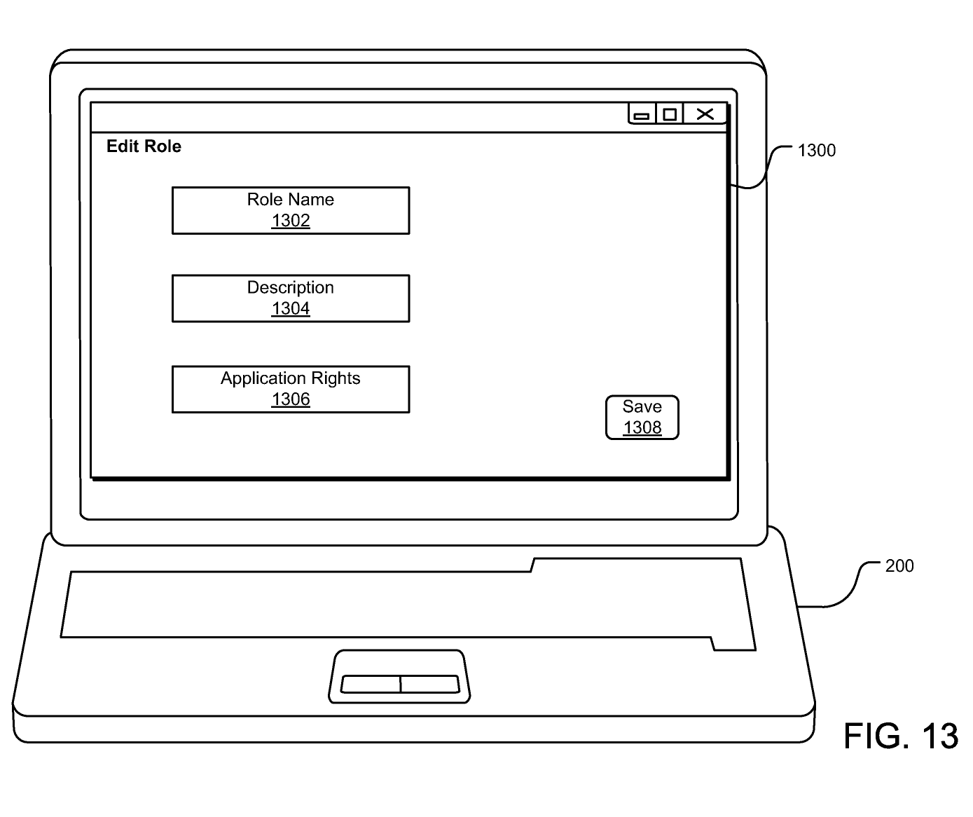

For example, selecting the edit button 1212 or the create new button 1202 displays an edit role page 1300, as shown in FIG. 13. Various fields in the edit role page 1300 may be used to define access rights for a role. For example, the name of the role and the description may be defined using a role name field 1302 and a description field 1304.

The application rights field 1306 defines the access permissions associated with the role, as described herein. In one implementation, the application rights field 1306 is a drop down menu of available access permissions which may be selected or deselected to define a set of access permissions attributable to the role. The available access permissions may include a right to: login; view a seismic catalog listing active surveys; create seismic surveys; delete seismic surveys and data sets; upload seismic data; download seismic data; view seismic sections; transfer seismic data to other parties; temporarily share seismic data with other parties; view a seismic actions log detailing the activity of parties relating to a survey; attach documents to seismic data; delete documents attached to seismic data; connect via the API 108; view documents attached to seismic data; make seismic journal entries; and delete seismic journal entries. However, other access permissions are contemplated.

FIG. 14 shows the user roster 1400 listing individual users having access to seismic data. The user roster 1400 may display every user having access to a survey, every user with login credentials within a company, or some combination thereof. In one implementation, the user roster 1400 displays information regarding a user and his/her role(s). The user roster 1400 displays: a user ID 1402; a full name 1404 of the user; a company 1406 with which the user is associated; a business unit 1408 within that company, where applicable; and role(s) 1410 assigned to the user. In one implementation, the user roster 1400 further includes a create new button 1416 to add a user associated with a company or a guest user to the user roster 1400 and buttons 1410, 1412, and 1414 to manage the user settings. The details button 1410 displays details regarding a user profile; the edit button 1412 permits editing of user access rights and settings; and the delete button 1414 deletes the user from the user roster 1400.

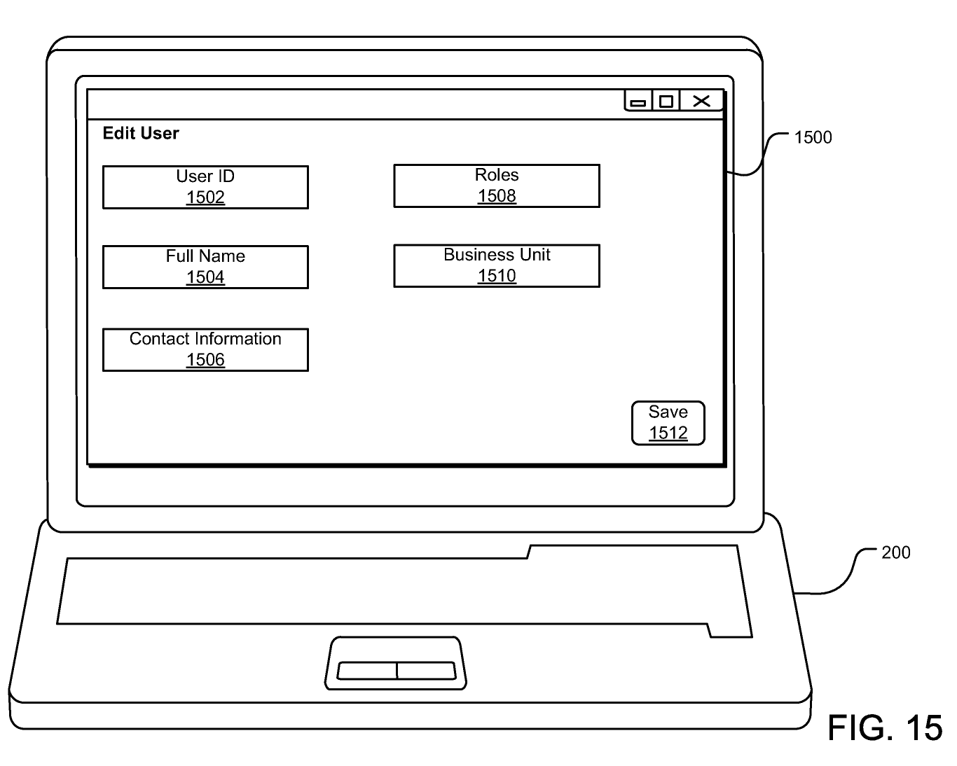

For example, selecting the edit button 1412 or the create new button 1416 displays an edit user page 1500, as shown in FIG. 15. Various fields in the edit user page 1500 may be used to define settings and roles for a user. For example, user ID field 1502, the full name field 1504, the roles field 1508, and the business unit field 1510 define the data shown in the user ID 1402, the full name 1404, the role(s) 1410, and the business unit 1408, respectively. Further, a contact information field 1506 may be used to put contact information for the user (e.g., the company 1406, an email address, telephone number, address, etc.). A save button 1512 saves the user information, which is then displayed in the user roster 1400.

FIG. 16 shows transfer information 1600 for seismic data associated with Survey 1. In one implementation, the transfer information 1600 provides a chain of custody and title for the seismic data and details the terms of such transfers. For example, the transfer information 1600 may show: an owner 1604 of the seismic data; a transferor 1606 of the seismic data; a transferee 1608 receiving a copy of the seismic data or a license to the seismic data; a type of transfer 1610 (e.g., assignment, license, sub-license, or other transfer); and a length 1612 of the transfer to show when a transfer is pending, active, or expired.

The transfer information 1600 further includes a create new transfer button 1602 to license, assign, provide a copy, or otherwise transfer seismic data to another party. The create new transfer button 1602 and the transfer button 1614 will only be available if the party viewing the transfer information 1600 has transfer permissions and the seismic data is eligible for transfer. For example, if seismic data is already licensed and sub-licensed and the no further licenses or sublicenses are permitted, the transfer button 1614 will not be available.

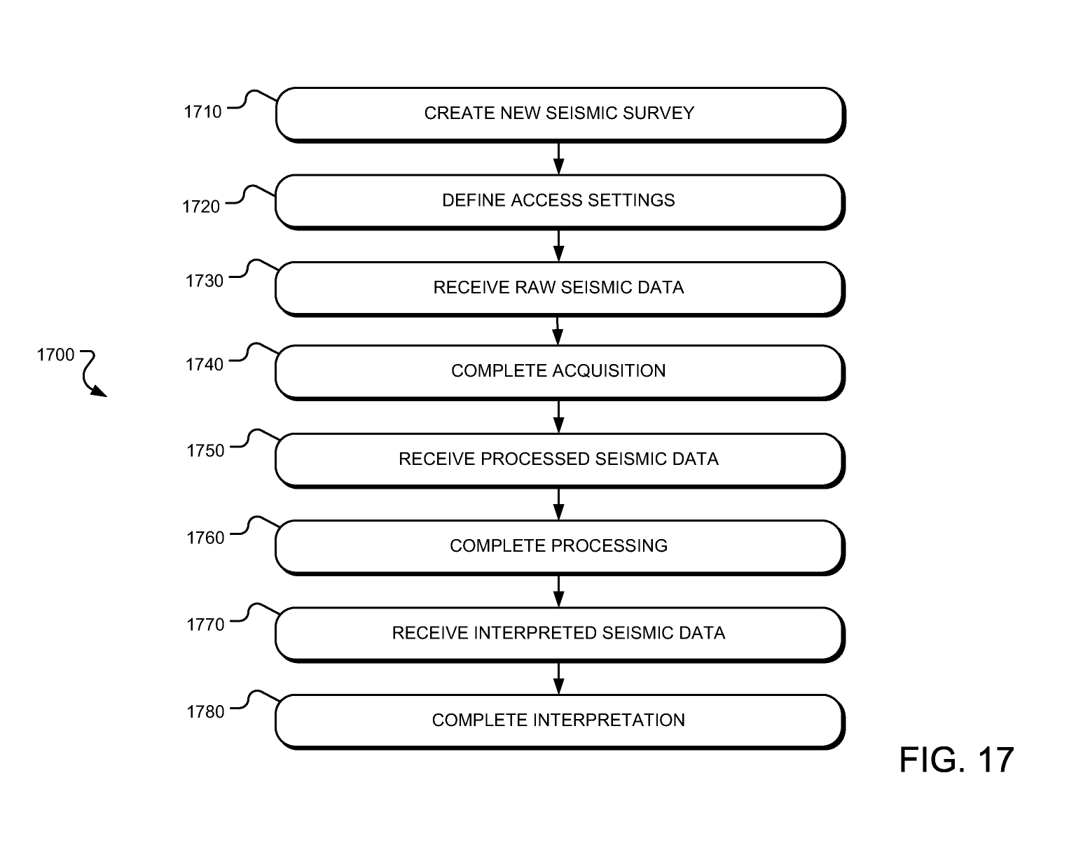

FIG. 17 is a flow chart illustrating example operations 1700 for managing the flow of and access to seismic data. In one implementation, a creating operation 1700 creates a new seismic survey. A defining operation 1720 defines role-based access rights for one or more parties associated with the new seismic survey and project statuses. The role-based access rights include company access rights, business unit access rights, and user access rights. Associated with each of the role-based access rights has a set of access permissions selected from available access permissions. The set of access permissions define what a company, business unit, or user may access or operations those parties may perform against seismic data.

A receiving operation 1730 acquires and uploads field seismic data to a cloud infrastructure. The field seismic data may be in the form of shot records along with ancillary data. In one implementation, the field seismic data is analyzed during quality control operations to determine whether the field seismic data is approved and the acquisition is complete. A completing operation 1740 completes and deactivates acquisition operations once the acquisition of the field seismic data is complete and the data is approved.

A second receiving operation 1750 receives and uploads multi-dimensional (e.g., 2-dimensional or 3-dimensional) seismic stack data that is generated using the field seismic data. In one implementation, the processed seismic data is analyzed during quality control operations to determine whether the processed seismic data is approved and the processing is complete. A completing operation 1760 completes and deactivates processing operations once the generation of the processed seismic data is complete and the data is approved.

A third receiving operation 1770 receives interpreted seismic data which may identify underground horizons, present topographic data, present filtered data, and/or present fault data. In one implementation, the interpreted seismic data is analyzed during quality control operations to determine whether the interpreted seismic data is approved and the interpretation is complete. A completing operation 1780 completes and deactivates interpretation operations once the interpretation of the processed seismic data is complete and the data is approved.

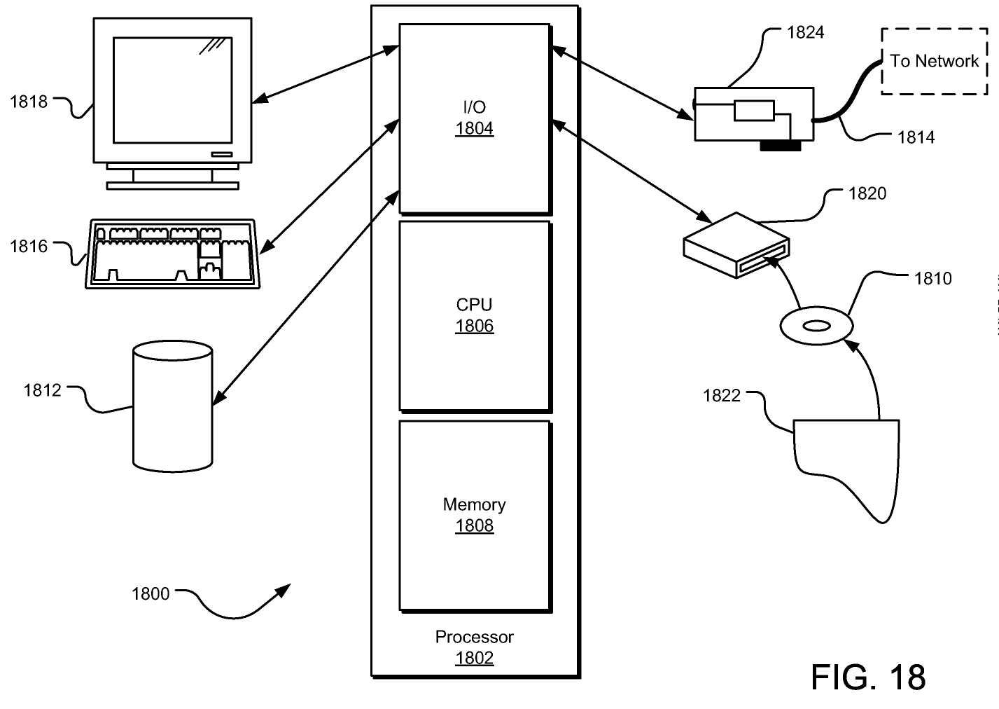

Referring to FIG. 18, a general purpose computer system 1800 is capable of executing a computer program product to execute a computer process is shown. Data and program files may be input to the computer system 1800, which reads the files and executes the programs therein. Some of the elements of the general purpose computer system 1800 are shown in FIG. 18, wherein a processor 1802 is shown having an input/output (I/O) section 1804, a Central Processing Unit (CPU) 1806, and memory 1808.

There may be one or more processors 1802, such that the processor 1802 of the computer system 1800 comprises the CPU 1806 or a plurality of processing units, commonly referred to as a parallel processing environment. The computer system 1800 may be a conventional computer, a distributed computer, or any other type of computer, such as one or more external computers made available via a network architecture, for example as described with respect to FIG. 1. The presently described technology is optionally implemented in software devices loaded in the memory 1808, stored on a configured DVD/CD-ROM 1810 or a storage unit 1812, and/or communicated via a wired or wireless network link 1814 on a carrier signal, thereby transforming the computer system 1800 in FIG. 18 to a special purpose machine for implementing the operations described herein.

The I/O section 1804 is connected to one or more user-interface devices (e.g., a keyboard 1816 and a display unit 1818), the storage unit 1812, and a disk drive 1820. In one implementation, the disk drive 1820 is a DVD/CD-ROM drive unit capable of reading the DVD/CD-ROM 1810, which typically contains programs and data 1822. In another implementation, the disk drive 1820 is a solid state drive unit.

Computer program products containing mechanisms to effectuate the systems and methods in accordance with the presently described technology may reside in the memory 1804, on the storage unit 1812, on the DVD/CD-ROM 1810 of the computer system 1800, or on external storage devices made available via a network architecture with such computer program products, including one or more database management products, web server products, application server products, and/or other additional software components. Alternatively, the disk drive 1820 may be replaced or supplemented by a floppy drive unit, a tape drive unit, or other storage medium drive unit. The network adapter 1824 is capable of connecting the computer system 1800 to a network via the network link 1814, through which the computer system 1800 can receive instructions and data embodied in a carrier wave. An example of such systems is personal computers. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 1800 is connected (by wired connection or wirelessly) to a local network through the network interface or adapter 1824, which is one type of communications device. When used in a WAN-networking environment, the computer system 1800 typically includes a modem, a network adapter, or any other type of communications device for establishing communications over the wide area network. In a networked environment, program modules depicted relative to the computer system 1800 or portions thereof, may be stored in a remote memory storage device. It is appreciated that the network connections shown are examples of communications devices for and other means of establishing a communications link between the computers may be used.

In an example implementation, seismic data management, sharing, storing, retrieving, and security software and other modules and services may be embodied by instructions stored on such storage systems and executed by the processor 1802. Some or all of the operations described herein may be performed by the processor 1802. Further, local computing systems, remote data sources and/or services, and other associated logic represent firmware, hardware, and/or software configured to control data access. Such services may be implemented using a general purpose computer and specialized software (such as a server executing service software), a special purpose computing system and specialized software (such as a mobile device or network appliance executing service software), or other computing configurations. In addition, one or more functionalities of the systems and methods disclosed herein may be generated by the processor 1802 and a user may interact with a Graphical User Interface (GUI) using one or more user-interface devices (e.g., the keyboard 1816, the display unit 1818, and the user devices 1804) with some of the data in use directly coming from online sources and data stores.

The system set forth in FIG. 18 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for managing a flow of and access to proprietary data in a cloud storage array, the method comprising:
receiving a plurality of uploads of the proprietary data;
maintaining an association of the proprietary data across the plurality of uploads;
assigning a role to a party with an interest in the proprietary data, the role defined by a set of access permissions; and
controlling access of the party to the proprietary data based on the assigned role.

2. The method of claim 1, wherein the proprietary data includes field and processed data.

3. The method of claim 1, wherein the proprietary data includes interpreted data.

4. The method of claim 3, wherein the interpreted data is processed seismic data and metadata.

5. The method of claim 1, wherein the party is a company commissioned to perform seismic survey services.

6. The method of claim 1, wherein the party is an individual user.

7. The method of claim 1, wherein the party is a business unit within a company.

8. The method of claim 1, wherein the set of access permissions specify operations allowable against the proprietary data.

9. The method of claim 8, wherein the operations allowable against the proprietary data include downloading the proprietary data, uploading the proprietary data, and viewing the proprietary data.

10. The method of claim 1, wherein the set of access permissions is selected from a list of available access permissions.

11. The method of claim 1, wherein the role is assigned based on a nature of services to be performed by the party with respect to the proprietary data.

12. One or more tangible computer-readable storage media storing computer-executable instructions for performing a computer process on a computing system, the computer process comprising:
receiving a plurality of uploads of proprietary data;
maintaining an association of the proprietary data across the plurality of uploads;
assigning a role to a party with an interest in the proprietary data, the role defined by a set of access permissions; and
controlling access of the party to the proprietary data based on the assigned role.

13. The one or more tangible computer-readable storage media of claim 12, wherein the proprietary data is multi-dimensional data sets.

14. The one or more tangible computer-readable storage media of claim 12, wherein the proprietary data comprises at least one of raw data, processed data, and interpreted data.

15. The one or more tangible computer-readable storage media of claim 12, wherein the proprietary data is seismic data.

16. The one or more tangible computer-readable storage media of claim 12, wherein the set of access permissions specify operations allowable against the proprietary data.

17. The one or more tangible computer-readable storage media of claim 12, wherein the set of access permissions is selected from a list of available access permissions.

18. A system comprising:
a proprietary data application configured to assign a role to a party with an interest in proprietary data having an association across a plurality of uploads into a computer server, the role defined by a set of access permissions, wherein the proprietary data application controls access of the party to the proprietary data based on the assigned role.

19. The system of claim 18, wherein the proprietary data is multi-dimensional data sets.

20. The system of claim 19, wherein the multi-dimensional data sets are seismic data sets.
